(19) United States
(12) Patent Application Publication
(10) Pub. No.: US 2026/0331827 A1
(43) Pub. Date: Oct. 22, 2026

(54) ELECTRICAL CONNECTOR AND METHOD OF FORMING SAME

(71) Applicant: Molex, LLC, Lisle, IL (US)

(72) Inventor: Sandeep CS, Bengaluru (IN)

(21) Appl. No.: 19/486,278

(22) PCT Filed: Jul. 3, 2024
(86) PCT No.: PCT/IB2024/056472

§ 371 Date: Nov. 20, 2025

(30) Foreign Application Priority Data
Jul. 3, 2023 (IN) 202321044413

(51) Int. Cl. H01R 13/627; H01R 12/75; H01R 24/20; H01R 25/14; H01R 43/26; H01R 101/00

(52) U.S. Cl. CPC H01R 13/6275; H01R 12/75; H01R 13/6271; H01R 24/20; H01R 25/142; H01R 43/26; H01R 2101/00; H01R 2201/26

(57) ABSTRACT

An electrical connector includes a plug assembly and a header assembly configured to electrically couple thereto. The plug assembly includes an insulative housing forming an open ended pocket, a conductive member mounted therewithin, and a lock and release assembly. The lock and release assembly includes a lock housing movably mounted within the insulative housing, a compression spring between the lock housing and the insulative housing, and a latch movably mounted on the lock housing. The latch is configured to move out of and into the pocket upon contact with the header assembly. A method of coupling the plug assembly with the header assembly is also provided.

### RELATED APPLICATION

This application claims priority to Indian Provisional Application No. 202321044413, filed Jul. 3, 2023, the contents of which are incorporated herein by reference in their entireties.

### TECHNICAL FIELD

This disclosure relates to an electrical connector provided for coupling to a single conductor assembly for use in high power connections, such as for use in battery applications of electric vehicles (EV) and hybrid electric vehicles (HEV). The electrical connector includes a header assembly and a plug assembly for providing a wire-to-board connection. The plug assembly easily connects to and disconnects from the header assembly.

### DESCRIPTION OF RELATED ART

Wire-to-board connectors are provided with a header assembly mounted to a printed circuit board or busbar and which is matable with a plug assembly which is coupled to a wire. Some prior art wire-to-board connectors provide for an easy connect and disconnect between the plug assembly and the header assembly so that the power source can be plugged and unplugged without unplugging the entire connector.

### SUMMARY

In an embodiment, an electrical connector includes a plug assembly electrically couplable with a header assembly. The plug assembly includes an insulative housing forming a pocket having an open lower end and a passageway in communication with the pocket, a conductive member mounted within the pocket, a lock and release assembly mounted within the insulative housing. The lock and release assembly includes a lock housing movably seated within the passageway, a compression spring within the passageway and between the lock housing and the insulative housing, and a latch movably mounted on the lock housing, wherein the latch seats within the passageway and is configured to move out of and into the pocket. The header assembly includes a header and a conductive male terminal. The header assembly seats within the pocket and engages the latch to cause the movement of the latch out of out of the pocket during engagement with the plug assembly. The male terminal seats within the conductive member when fully engaged with the plug assembly.

The latch includes an elongated slot therein and the lock housing includes a projection which seats within the elongated slot. The projection slides along the elongated slot during movement of the lock and release assembly.

The elongated slot is parallel to a longitudinal axis of the insulative housing when the header assembly is disengaged from the plug assembly and when the header is fully engaged with the plug assembly. The slot is angled relative to the longitudinal axis of the insulative housing during seating of the header with the plug assembly.

In an embodiment, the latch includes a second projection which seats within an opening of the housing, and the latch rotates around the second projection. The second projection defines a vertical axis, and the projection of the lock housing defines a vertical axis.

The header may include a locking portion on the header, and the latch is connected to the lock housing via a projection within a slot. During a mating operation, the locking portion applies force on the latch thereby displacing the latch angularly and the lock housing linearly, and in turn compressing the compression spring. Once the locking portion moves past the latch, the compression spring applies a force onto the lock housing to move the lock housing and the latch to an initial position. During disengagement of the header assembly from the plug assembly, an external force is applied to the lock housing, thereby compressing the spring and angularly displacing the latch.

The slot is parallel to a longitudinal axis of the insulative housing when the header assembly is disengaged from the plug assembly and when the header is fully engaged with the plug assembly, and the slot is angled relative to the longitudinal axis of the insulative housing during seating of the header with the plug assembly.

In an embodiment, the locking portion is integrally formed with the header. In another embodiment, the locking portion is a separate component attached to the header.

The header may be formed of an insulative material.

In an embodiment, the compression spring engages with a housing portion which is separate from the insulative housing and is coupled thereto. In an embodiment, the housing portion includes flexible arms which snap-fit to the insulative housing.

In an embodiment, the pocket is separated by a wall into a recess within the wall and a circumferential space surrounding the wall. The passageway is in direct communication with the circumferential space. The header seats within the circumferential space and the conductive contact seats within the recess.

In an embodiment, the header has passageway therethrough in which the male terminal is mounted.

In an embodiment, the header has a flange extending outwardly therefrom.

In an embodiment, the male terminal has a coupling portion configured to couple to a printed circuit board or busbar. The coupling portion may be threaded.

### BRIEF DESCRIPTION OF DRAWINGS

The organization and manner of the structure and operation of the disclosed embodiments, together with further objects and advantages thereof, may best be understood by reference to the following description, taken in connection with the accompanying drawings, which are not necessarily drawn to scale, wherein like reference numerals identify like elements in which:

FIG. 1 depicts a perspective view of an electrical connector;

FIG. 2 depicts an exploded perspective view of the plug assembly;

FIG. 3 depicts a bottom plan view of a plug assembly of the electrical connector;

FIG. 4 depicts a cross-sectional view of the plug assembly along line 4-4 of FIG. 3;

FIGS. 5 and 6 depict cross-sectional views of the plug assembly;

FIG. 7 depicts a perspective view of a quick lock and easy release assembly of the plug assembly;

FIG. 8 depicts an exploded perspective view of the quick lock and easy release assembly;

FIG. 9 depicts a bottom plan view of the quick lock and easy release assembly;

FIG. 10 depicts a cross-sectional view of the plug assembly along line 7-7 of FIG. 3;

FIG. 11 depicts a bottom plan view of a lock housing of the quick lock and easy release assembly;

FIG. 12 depicts a bottom plan view of a latch of the quick lock and easy release assembly;

FIG. 13 depicts an exploded perspective view of a header assembly of the electrical connector; and

FIG. 14 depicts the cross-sectional view of FIG. 4, but with the plug assembly assembled to the header assembly.

### DETAILED DESCRIPTION

The detailed description that follows describes exemplary embodiments and is not intended to be limited to the expressly disclosed combination(s). Therefore, unless otherwise noted, features disclosed herein may be combined together to form additional combinations that were not otherwise shown for purposes of brevity.

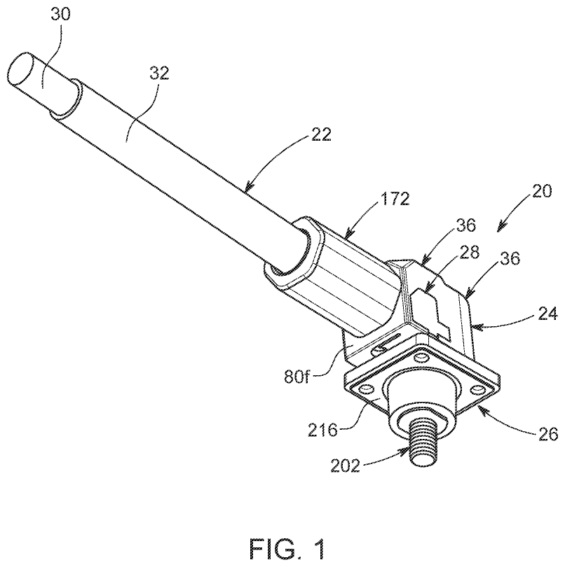

An electrical connector 20, see FIG. 1, is provided for coupling to a single conductor assembly 22 for use in high power connections, such as for use in battery applications of electric vehicles (EV) and hybrid electric vehicles (HEV). The electrical connector 20 provides a wire-to-board connector and includes a plug assembly 24, which is electrically coupled to the single conductor assembly 22, and a header assembly 26, which is coupled to a printed circuit board or busbar (not shown). The plug assembly 24 and the header assembly 26 can be easily mated together to form an electrical connection and can be easily unmated. The electrical connector 20 includes a quick lock and easy release assembly 28 for allowing the plug assembly 24 to be plugged into the header assembly 26 while allowing the easy release thereof without the use of tools.

The single conductor assembly 22 is conventional and includes a conductive wire 30 surrounded by insulative jacket 32.

The plug assembly 24 includes an insulative housing 36 having a conductive plug terminal assembly 38 provided therein. The plug terminal assembly 38 is electrically coupled to the wire 30 of the single conductor assembly 22.

The plug terminal assembly 38 includes a conductive member which in the embodiment as shown includes a conductive barrel 40, a conductive contact 42 mounted within the barrel 40, a conductive lug terminal 44 on which the barrel 40 is mounted, and an end cap 46. While these components 40, 42, 44, 46 are shown and described as separate components, one or all of these components may be integrally formed.

In the embodiment as shown, the barrel 40 has a wall 48, which may be cylindrical, and which defines a passageway 50 that extends from a lower end to an upper end thereof. A flange 52 may extend radially inwardly from the wall 48 at the lower end to restrict the size of the passageway 50. A centerline of the barrel 40 is provided between the ends and defines a longitudinal axis 54.

In the embodiment as shown, the contact 42 generally forms a hollow shape which generally conforms to the shape of the passageway 50 of the barrel 40. The contact 42 may be formed of an alloy with gold plating. In an embodiment, the contact 42 is formed from a ring-like connecting portion 56 having a plurality of separate flexible beams 58 cantilevered therefrom such that a passageway 60 is formed therein which extends from a lower end to an upper end thereof. The specifics of one embodiment of the contact 42 are described in U.S. Pat. No. 10,892,576 , which is incorporated by reference herein. Other configurations for the contact 42 may also be utilized. The contact 42 seats within the passageway 50 of the barrel 40 such that the lower end of the contact 42 generally aligns with the lower end of the barrel 40, and the centerlines align. An outer surface of the connecting portion 56 engages with an inner surface of the wall 48 of the barrel 40.

In the embodiment as shown, the end cap 46 has a wall 62, which may be cylindrical, and has lower end thereof which is closed by a wall 64 thereby defining a recess. A flange 66 extends radially outward from the upper end of the wall 62. An outer surface of the wall 62 engages against an inner surface of the connecting portion 56. The flange 66 engages against an upper end of the connecting portion 56 of the contact 42 and the upper end of the wall 48 of the barrel 40. As a result, the connecting portion 56 is sandwiched between the barrel 40 and the end cap 46.

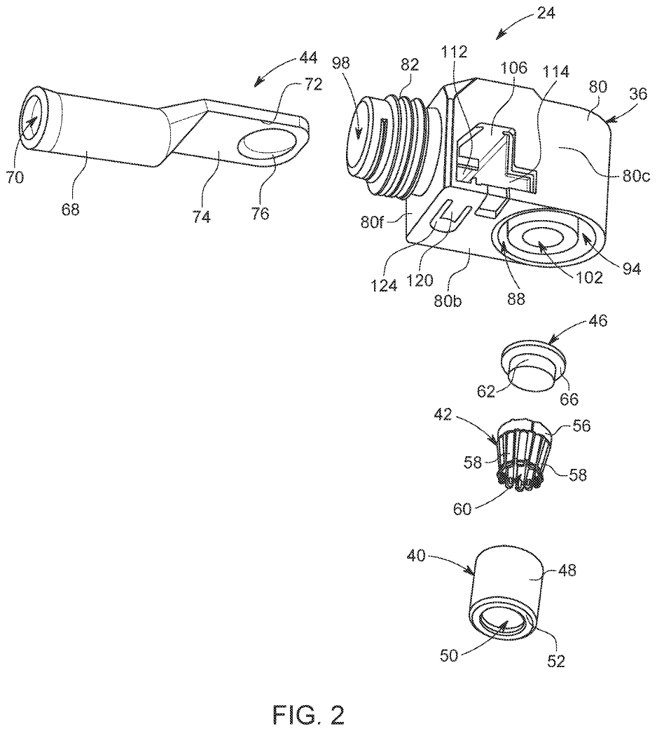

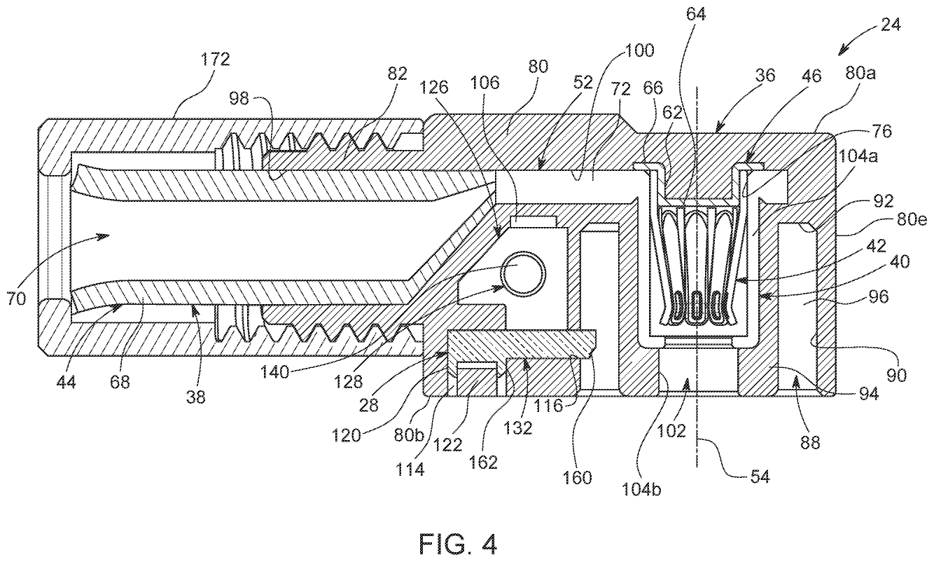

In the embodiment as shown, the lug terminal 44 has a body portion 68 which defines an open ended cavity 70 into which the wire 30 is inserted and electrically coupled therewith, and a head portion 72 extending from body portion 68 at the closed end of the cavity 70. In an embodiment as shown in FIGS. 2 and 4, the head portion 72 has a flat base 74 and an opening 76 therethrough. The end cap 46 seats within the opening 76 and the flange 66 engages against the upper end of the head portion 72.

The insulative housing 36 includes a main body 80 and a threaded coupling 82 integrally formed therewith and extending from a rear end thereof.

The main body 80 has a top surface 80a, an opposite bottom surface 80b, opposite side surfaces 80c, 80d, a front surface 80e, and an opposite rear surface 80f. A longitudinal axis 84 extends between the front surface and rear surfaces 80e, 80f, and a lateral axis 86, which is transverse to the longitudinal axis 84, extends between the side surfaces 80c, 80d. A pocket 88, which may be cylindrical, extends upward from the bottom surface 80b and is defined by a surrounding wall surface 90 and an upper wall surface 92.

A cylindrical wall 94 extends downward from the upper wall surface 92 of the pocket 88. An outer surface of the cylindrical wall 94 is spaced from the surrounding wall surface 90 such that a circumferential space 96 having an open lower end is defined therebetween. A lower end of the cylindrical wall 94 may align with the lower surface 80b of the main body 80.

A first longitudinally extending passageway 98 is provided through the threaded coupling 82 of the housing 36. A second longitudinally extending passageway 100 is provided through the main body 80 of the housing 36 and extends from the front end of the passageway 98. A vertically extending recess 102 is provided through the cylindrical wall 94 and extends from the front end of the passageway 100. The recess 102 has an upper section 104a which extends downward from the front end of the passageway 100, and a lower section 104b that extends from the lower end of the upper section 104a and has a lower end which is open to the bottom of the housing 36. The upper section 104a has a diameter which is greater than the lower section 104b. The body portion 68 of the lug terminal 44 of the plug terminal assembly 38 is received in the passageway 98. The head portion 72 of the lug terminal 44 is received in the passageway 100 and extends into the recess 102. The barrel 40, contact 42 and end cap 46 are received in the recess 102 as described herein.

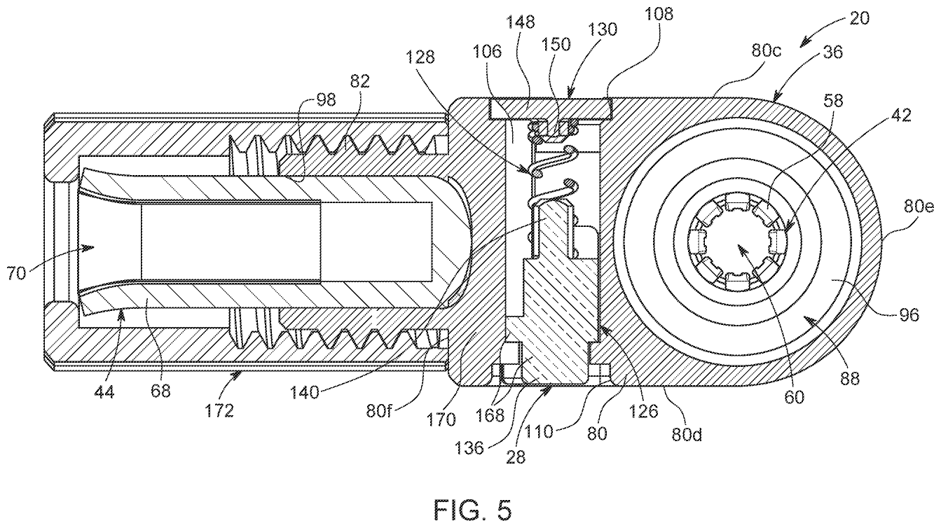

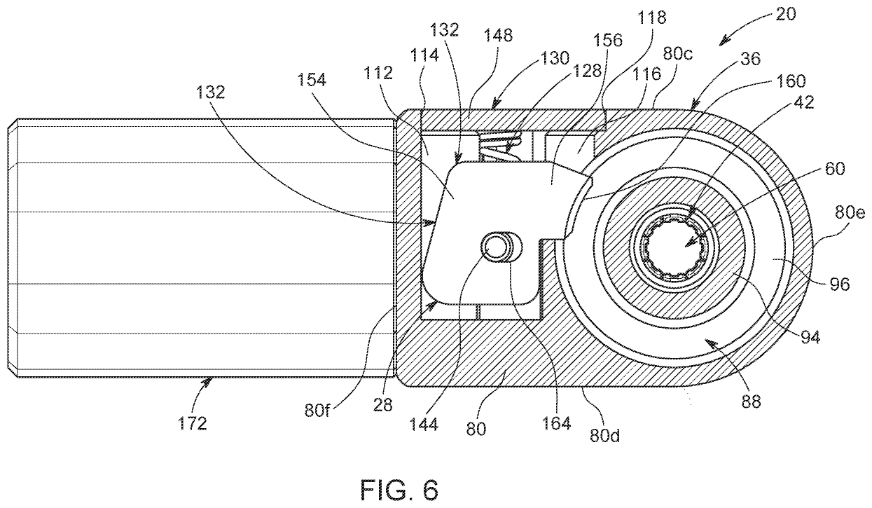

A first laterally extending passageway 106, see FIGS. 2, 4 and 10, extends between the side surfaces 80c, 80d in a section of the main body 80 that is rearward of the circumferential space 96 and has openings 108, 110 through the respective side surfaces 80c, 80d. A second laterally extending passageway 112, see FIGS. 2, 5 and 10, extends from the side surface 80c toward the side surface 80d and is below the first passageway 106. The second passageway 112 has an opening 114 through side surface 80c that is continuous with the opening 108. A longitudinally extending passageway 116, see FIG. 6, extends longitudinally from the second passageway 112 into the circumferential space 96, and further extends laterally between approximately a midpoint of the second passageway 112 and the side surface 80c. The longitudinally extending passageway 116 is vertically below the first passageway 106. The longitudinally extending passageway 116 has an opening 118 in side surface 80c that is continuous with the opening 114, but is not open to side surface 80d. The first, second and third passageways 106, 112, 116 form a common cavity in which the quick lock and easy release assembly 28 is received as described herein.

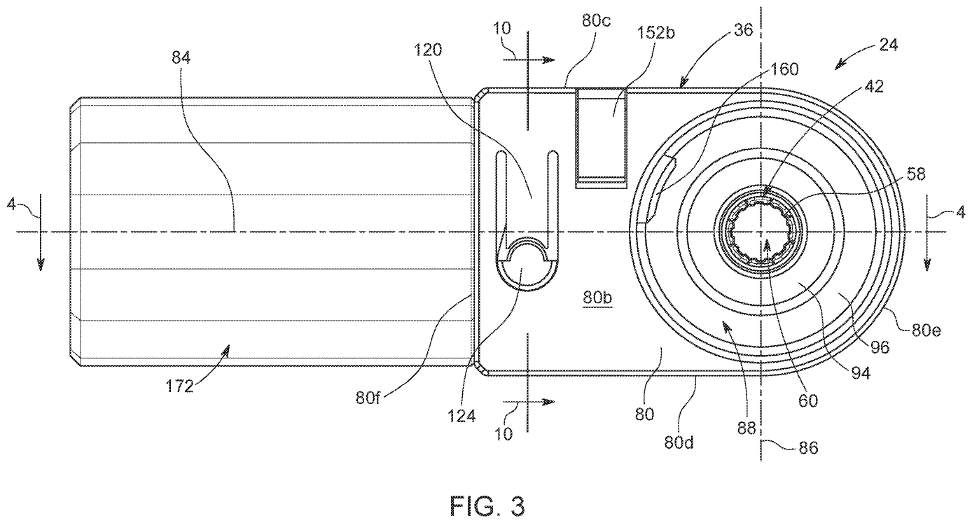

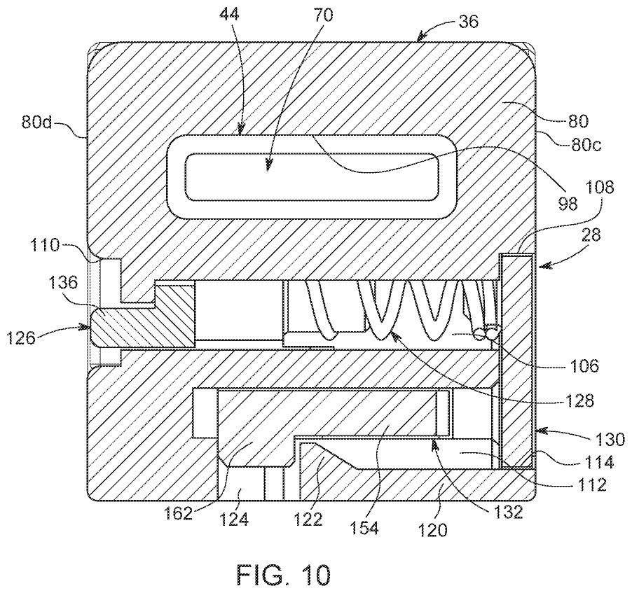

As shown in FIGS. 3 and 10, a flexible finger 120 having a barbed end 122 forms part of the bottom surface 80b of the main body 80 rearward of the pocket 88. The barbed end 122 extends into the second passageway 112. The flexible finger 120 extends laterally along the bottom surface 80b. A cylindrical opening 124 is provided through the bottom surface 80b at the end of the flexible finger 120. The opening 124 is continuous with the second passageway 112.

The lug terminal 44 is within the passageways 98, 100 and the body portion 68 extends from the threaded coupling 82 such that the open ended cavity 70 is exposed from the housing 36. The front end of the head portion 72 of the lug terminal 44, the barrel 40 and the contact 42 are within the upper section 104a of the recess 102. The lower section 104b of the recess 102 is open. The housing 36 fills the recess formed by the end cap 46. The housing 36 may be formed by overmolding over the assembled lug terminal 44, barrel 40 and contact 42. The separate flexible beams 58 of the contact 42 can be viewed when looking through the bottom of the plug assembly 24, see FIG. 3.

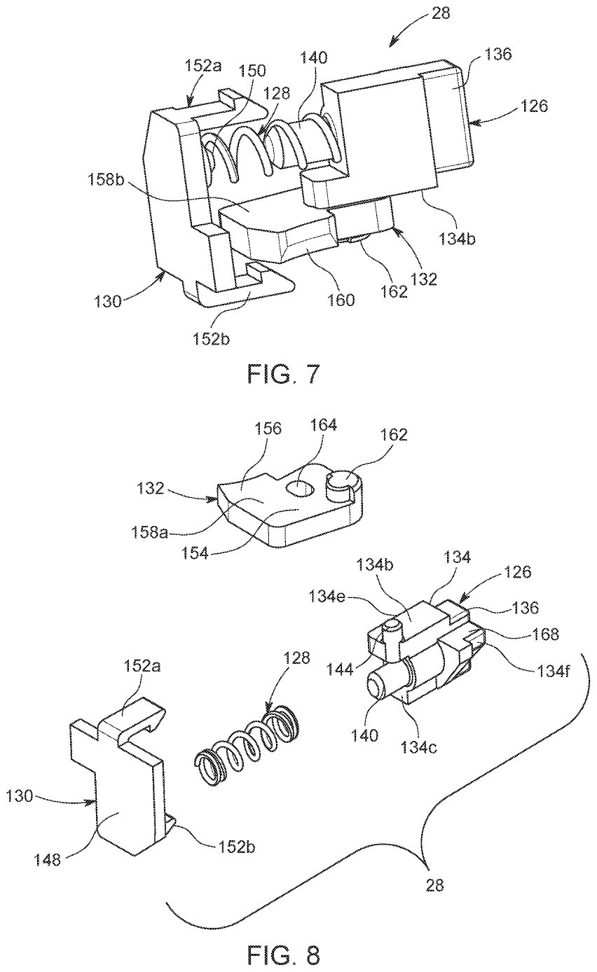

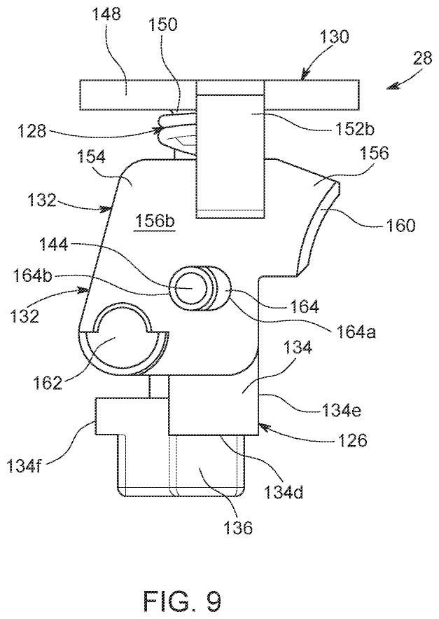

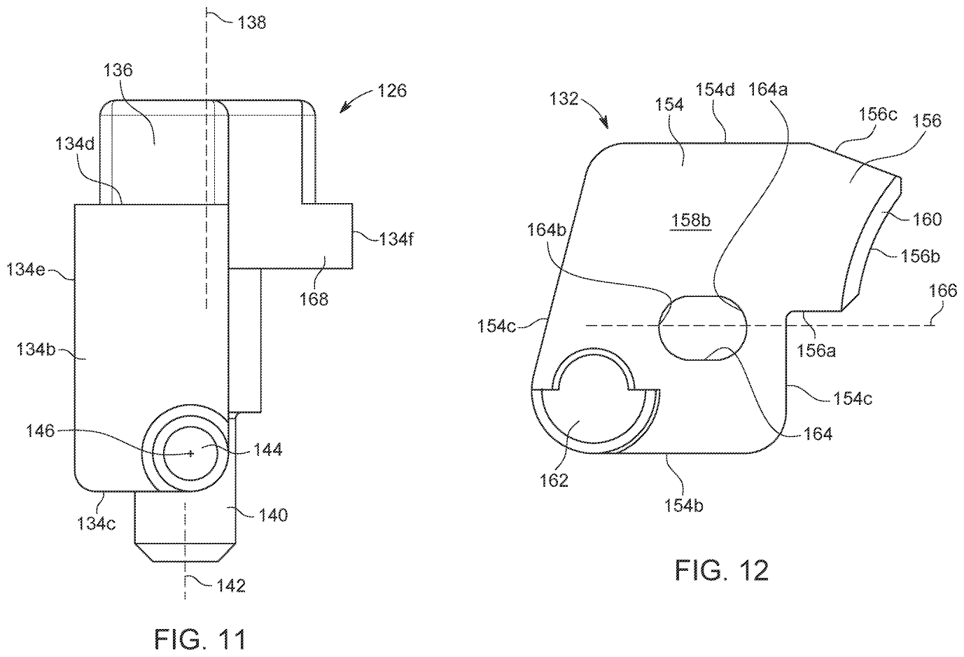

The quick lock and easy release assembly 28 is shown in FIGS. 7-12 and allows for the plug assembly 24 to be plugged into the header assembly 26 while allowing the easy release thereof without the use of tools. The quick lock and easy release assembly 28 is positioned within the cavity formed by the passageways 106, 112, 116. The quick lock and easy release assembly 28 includes a lock housing 126, a compression spring 128, a housing portion 130 and a latch 132.

The lock housing 126, see FIGS. 7-9, has a main body 134 having a top surface 134a, an opposite bottom surface 134b, an inner side surface 134c, an opposite outer side surface 134d, a front surface 134e, and an opposite rear surface 134f, and a digit engaging portion 136 extending from the outer side surface 134d. The main body 134 has a lateral axis 138 extending from the inner side surface 134c to the outer side surface 134d. The top and bottom surfaces 134a, 134b are planar. The digit engaging portion 136 is dimensionally smaller than the main body 134. A first projection 140 extends from the inner side surface 134c and has lateral axis 142 that is parallel to the lateral axis 138, but offset from the lateral axis 138 toward the front surface 134e. A second projection 144 extends from the bottom surface 134b and is provided proximate to the inner side surface 134c. A center 146 of the second projection 144 aligns, or generally aligns, with the lateral axis 142 of the first projection 140.

The housing portion 130 has an end plate 148 from which a projection 150 extends at approximately the center thereof, an upper flexible arm 152a extending from an upper end of the end plate 148 and having a barb at an end thereof, and a lower flexible arm 152b extending from a lower end of the end plate 148 and having a barb at an end thereof.

As best shown in FIG. 12, the latch 132 is generally L-shaped having a first section 154 which is generally formed as a square, and a second section 156 which is generally square. The first generally square section 154 is defined by outer edges 154a, 154b, 154c and 154d. In the embodiment as shown, edges 154b and 154d are parallel to, or substantially parallel to, each other. Edge 154a is perpendicular to, or substantially perpendicular to, edges 154b and 154d. Edge 154c is generally perpendicular to edges 154b and 154d, and generally parallel to edge 154a. The second generally square section 156 is defined by outer edges 156a, 156b and 156c. The second generally square section 156 starts at the midpoint of the edge 154a and extends to the edge 154d. The first edge 156a extends perpendicular to the first edge 154a and from the midpoint of the first edge 154a, the second edge 156b extends generally perpendicular to the first edge 156a, and the third edge 156c extends generally perpendicular to the second edge 156b and generally parallel to the first edge 156a. The latch 132 has opposite bottom and top surfaces 158a, 158b and opposite side surfaces (defined by edges 154b and 154d, 156c) that extend therebetween, and opposite rear and front surfaces (rear surface is defined by edge 154c and front surface is defined by edges 156b, 156a, 154a). The edge 156b is curved and has a tapered surface 160 which extends from the bottom surface 158a to the top surface 158b.

A cylindrical button projection 162 extends from the bottom surface 158a of the first generally square section 154 at the corner between the edges 154b and 154c. A vertical axis defined by the second projection 144 is parallel to a vertical axis defined by the button projection 162. An elongated slot 164 is provided through the first generally square section 154 and is generally offset longitudinally from the second generally square section 156. The slot 164 has parallel opposite sides and opposite first and second ends 164a, 164b. An axis 166 extends along the length of the slot 164. The end 164a is proximate to, but spaced from edge 154a and the end 164b is proximate to, but spaced from edge 154c.

The spring 128 seats over the projection 140 of the lock housing 126 and the projection 150 of the housing portion 130, and extends between the lock housing 126 and the end plate 148 of the housing portion 130. The bottom surface 134b of the lock housing 126 seats on top of the top surface 158b of the latch 132, with the second projection 144 of the lock housing 126 seated within the elongated slot 164 of the latch 132. The second projection 144 forms a key within the slot 164. In use, the latch 132 slides along the bottom surface 134b of the lock housing 126. The quick lock and easy release assembly 28 is inserted through the openings 108, 114, 118 in the side surface 80c and into the cavity formed by the passageways 106, 112, 116 by first inserting the digit engaging portion 136 through the openings 108, 114, 118 and sliding the quick lock and easy release assembly 28 laterally relative to the housing 36. The button projection 162 aligns with the flexible finger 120 which flexes outward from the bottom surface 80b to allow the button projection 162 to seat within the opening 124 and trap it therein. The lock housing 126, the compression spring 128 and the housing portion 130 seat within the passageway 106 and the latch 132 seats within the passageways 112, 116. The flexible arms 152a, 152b snap-lock the housing portion 130 into mating recesses in the housing 36. Other means for coupling the housing portion 130 and the main body 80 are within the scope of the present disclosure. The lock housing 126 has features 168 which mate with corresponding features 170 on the main body 80 of the housing 36 such that the lock housing 126 can only be slid along the lateral axis 86 of the housing 36. The digit engaging portion 136 sits within the opening 110 in the side surface 80d. While the housing portion 130 is described as part of the quick lock and easy release assembly 28 herein, the housing portion 130 forms part of the main body 80 and may be integrally formed therewith instead of coupled thereto as described herein.

When the plug assembly 24 is not inserted into the header assembly 26, the second section 156 of the latch 132 in an initial position and protrudes into the circumferential space 96 as shown in FIGS. 4 and 6 and the axis 166 of the slot 164 is parallel to the longitudinal axis 84 of the housing 36. The tapered surface 160 can be viewed when looking through the bottom of the plug assembly 24. The second projection 144 is proximate to the second end 164b of the elongated slot 164 and the spring 128 is expanded.

A sealing boot 172 is threaded onto the threaded coupling 82 and covers the front end of the single conductor assembly 22.

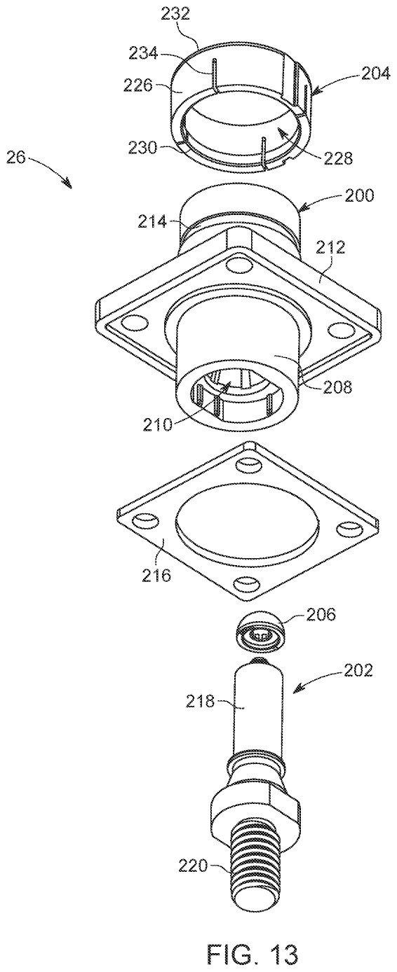

As shown in FIG. 13, the header assembly 26 includes a header 200, a conductive male terminal 202 mounted within the header 200, and a locking portion 204 on the header 200. The locking portion 204 may be separately formed as shown in the drawings, or may be integrally formed with the header 200. The male terminal 202 is mounted to the printed circuit board or busbar and couples with the plug terminal assembly 38. In an embodiment, an insulative touch safe cap 206 is mounted on an upper end of the male terminal 202. The header 200 and the locking portion 204 may be formed of an insulative material.

The header 200 includes a cylindrical wall 208 which defines a passageway 210 that extends from an upper end to a lower end thereof. A flange 212 may extend outward from the wall 208, and may be positioned at a midpoint thereof. The wall 208 has a reduced section 214 which may be formed as a circumferential groove in its outer surface above the flange 212. The reduced section 214 is spaced from the upper end of the wall 208. A seal 216 may be provided on a lower surface of the flange 212 and surrounds the wall 208.

The male terminal 202 has a shaft 218 which seats within the passageway 210 and a coupling portion 220 which extends from a lower end of the passageway 210. The wall 208 has a mating structure 222 which holds a lower portion of the shaft 218. An upper portion of the shaft 218 extends from the mating structure 222 and is spaced from the wall 208 by a circumferential space 224. The coupling portion 220 can take a variety of forms to provide different means for coupling, such as threaded as shown, for a crimp connection, for connection to the printed circuit board or busbar, etc. The flange 212 may sit on the surface of the printed circuit board or busbar.

If provided as a separate component, the locking portion 204 has an outer cylindrical wall 226 having a passageway 228 that extends from an upper end to a lower end thereof, and a flange 230 at the lower end that extends radially inward into the passageway 228. The upper end of the cylindrical wall 226 may have a bevel 232 thereon. The flange 230 is integrally formed with the wall 226 as one piece. The flange 230 restricts the size of the passageway 228 at the lower end. The flange 230 seats within the reduced section 214 and the wall 226 surrounds the wall 208. The wall 226 and the flange 230 have a plurality of slits 234 that extend upward from the lower end. The slits 234 allow the wall 226 and the flange 230 to flex outwardly when the locking portion 204 slides over the upper end of the wall 208 and along the wall 208 until the flange 230 seats within the reduced section 214. If integrally formed, the locking portion 204 provides an enlarged area at the top of the wall 208.

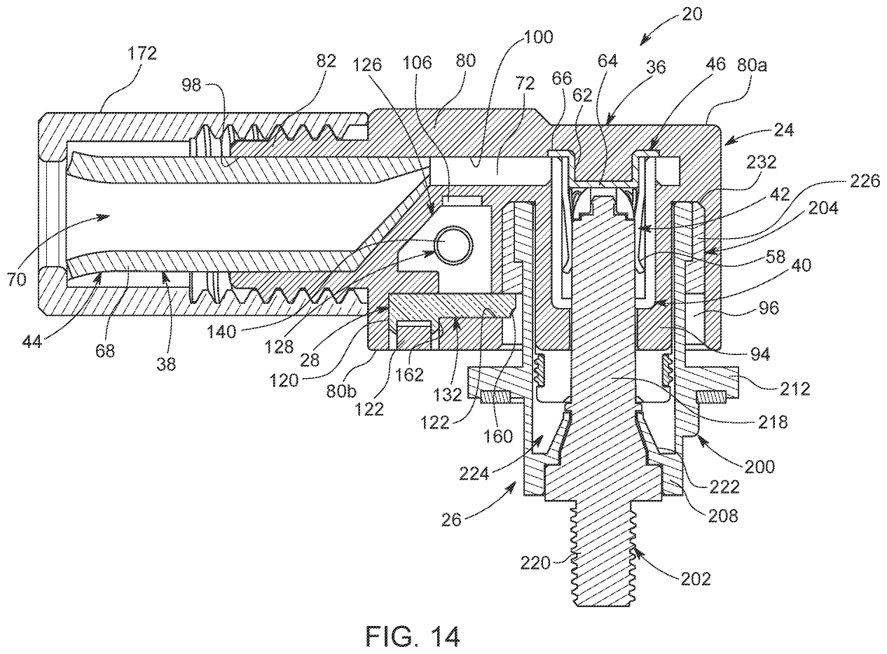

When the plug assembly 24 coupled with the header assembly 26, the locking portion 204 and upper end of the wall 208 above the flange 212 enter into the circumferential space 96 and the upper portion of the shaft 218 enters into the recess 102. Upon continued relative movement, the outer cylindrical wall 226 of the locking portion 204, specifically the bevel 232 if provided, engages with the tapered surface 160 of the latch 132. As the plug assembly 24 is continued to be inserted into the header assembly 26, the locking portion 204 applies force on the latch 132, thereby displacing the latch 132 angularly. The latch 132 rotates around the button projection 162 into an engaging position and the tapered surface 160 moves into the passageway 116 and out of the circumferential space 96. In the engaging position, the axis 166 of the slot 164 is angled relative to the longitudinal axis 84 of the housing 36. The second projection 144 translates along the elongated slot 164 toward the end 164a which causes the lock housing 126 to move laterally in a linear manner and toward the housing portion 130 and thereby compressing the spring 128. The end of the shaft 218 engages with the lower ends of the beams 58 of the contact 42 and the beams 58 flex around the shaft 218 such that the shaft 218 enters into the passageway 60 of the contact 42. Once the outer cylindrical wall 226 of the locking portion 204 moves upward past the latch 132, the spring 128 expands and applies a force onto the lock housing 126 which causes the lock housing 126 to move away from the housing portion 130 and the second projection 144 to slide again toward the end 164b until latch 132 pivots around button projection 162 and the curved edge 156b engages against the outer surface of the cylindrical wall 208, and the top surface 158a of the latch 132 engages with the lower end of the locking portion 204 as shown in FIG. 14. The axis 166 of the slot 164 returns to be parallel to the longitudinal axis 84 of the housing 36. The beams 58 of the contact 42 engage with the shaft 218.

The male terminal 202 can engage the contact 42 before engagement of the locking portion 204 with the latch 132. The male terminal 202 can engage the contact 42 after engagement of the locking portion 204 with the latch 132. The male terminal 202 can engage the contact 42 simultaneously with engagement of the locking portion 204 with the latch 132.

In an embodiment, power flows from the wire 30, through the lug terminal 44, through the barrel 40, though the contact 42, through the male terminal 202, and to the printed circuit board or busbar.

To unlock the plug assembly 24 from the header assembly 26, an external force is applied to the digit engaging portion 136, for example the digit engaging portion 136 is depressed by a user's finger or thumb. As a result, the lock housing 126 moves toward the housing portion 130 and compresses the spring 128. This causes the second projection 144 to again translate along the elongated slot 164 toward the end 164a which causes the latch 132 to rotate around button projection 162 and move toward the rear end of the housing 36 within the passageway 106 and withdraw from the circumferential space 96. The plug assembly 24 can thereafter be easily pulled out from the header assembly 26.

The use of the terms “a” and “an” and “the” and “at least one” and similar references in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All processes described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. An electrical connector comprising:
a plug assembly including
an insulative housing forming a pocket having an open lower end and a passageway in communication with the pocket,
a conductive member mounted within the pocket, and
a lock and release assembly mounted within the insulative housing, the lock and release assembly including a lock housing movably seated within the passageway, a compression spring within the passageway and between the lock housing and the insulative housing, and a latch movably mounted on the lock housing, wherein the latch seats within the passageway and is configured to move out of and into the pocket; and
a header assembly configured to electrically couple to the plug assembly, the header assembly including a header and a conductive male terminal, wherein the header assembly seats within the pocket and engages the latch to cause the movement of the latch out of out of the pocket during engagement with the plug assembly, and wherein the male terminal seats within the conductive member when fully engaged with the plug assembly.

2. The electrical connector of claim 1, wherein the latch includes an elongated slot therein and the lock housing includes a projection which seats within the elongated slot, wherein the projection slides along the elongated slot during movement of the lock and release assembly.

3. The electrical connector of claim 2, wherein the elongated slot is parallel to a longitudinal axis of the insulative housing when the header assembly is disengaged from the plug assembly and when the header is fully engaged with the plug assembly, and the slot is angled relative to the longitudinal axis of the insulative housing during seating of the header with the plug assembly.

4. The electrical connector of claim 2, wherein the latch includes a second projection, wherein the second projection seats within an opening of the housing and the latch rotates around the second projection.

5. The electrical connector of claim 4, wherein the second projection defines a vertical axis, and the projection of the lock housing defines a vertical axis.

6. The electrical connector of claim 1, further comprising:
a locking portion on the header; and
wherein the latch is connected to the lock housing via a projection within a slot, and
wherein during a mating operation, the locking portion applies force on the latch thereby displacing the latch angularly and the lock housing linearly, and in turn compressing the compression spring.

7. The electrical connector of claim 6, wherein once the locking portion moves past the latch, the compression spring applies a force onto the lock housing to move the lock housing and the latch to an initial position.

8. The electrical connector of claim 6, wherein during disengagement of the header assembly from the plug assembly, an external force is applied to the lock housing, thereby compressing the spring and angularly displacing the latch.

9. The electrical connector of claim 6, wherein the slot is parallel to a longitudinal axis of the insulative housing when the header assembly is disengaged from the plug assembly and when the header is fully engaged with the plug assembly, and the slot is angled relative to the longitudinal axis of the insulative housing during seating of the header with the plug assembly.

10. The electrical connector of claim 6, wherein the locking portion is integrally formed with the header.

11. The electrical connector of claim 6, wherein the locking portion is a separate component attached to the header.

12. The electrical connector of claim 1, wherein the header is formed of an insulative material.

13. The electrical connector of claim 1, wherein the compression spring engages with a housing portion of the insulative housing, the housing portion being a separate component from the insulative housing and coupled thereto.

14. The electrical connector of claim 1, wherein the pocket is separated by a wall into a recess within the wall and a circumferential space surrounding the wall, wherein the passageway is in direct communication with the circumferential space, and wherein the header seats within the circumferential space and the conductive contact seats within the recess.

15. The electrical connector of claim 1, wherein the header has a passageway therethrough in which the male terminal is mounted.

16. The electrical connector of claim 15, wherein the header has a flange extending outwardly therefrom.

17. The electrical connector of claim 1, wherein the male terminal has a coupling portion configured to couple to a printed circuit board or busbar.

18. A method of coupling an electrical connector comprising:
inserting a conductive male terminal of a header assembly into a pocket of an insulative housing of a plug assembly;
engaging the conductive male terminal with a latch of a lock and release assembly of the plug assembly, the lock and release assembly including a lock housing coupled with the insulative housing, the latch connected to the lock housing via a projection within a slot, and a compression spring positioned between the lock housing and the insulative housing, the latch being positioned within the pocket in a first position prior to engagement with the conductive male terminal and the latch is connected to the lock housing, and
further engaging the conductive male terminal with the latch thereby displacing the latch angularly to a second position, displacing the lock housing linearly, and compressing the compression spring; and
engaging the conductive male terminal with a conductive contact of the lock and release assembly, and
wherein upon the latch engaging with a reduced section of the male terminal, the latch is automatically returned to the first position by expansion of the compression spring.

19. The method of claim 18, wherein the conductive male terminal engages with the conductive contact simultaneously with engagement of the conductive male terminal with the latch.

20. A method of coupling and decoupling an electrical connector comprising:
inserting a conductive male terminal of a header assembly into a pocket of an insulative housing of a plug assembly;
engaging the conductive male terminal with a latch of a lock and release assembly of the plug assembly, the lock and release assembly including a lock housing coupled with the insulative housing, the latch connected to the lock housing via a projection within a slot, and a compression spring positioned between the lock housing and the insulative housing, the latch being positioned within the pocket in a first position prior to engagement with the conductive male terminal and the latch is connected to the lock housing, and
further engaging the conductive male terminal with the latch thereby displacing the latch angularly to a second position, displacing the lock housing linearly, and compressing the compression spring;
engaging the conductive male terminal with a conductive contact of the lock and release assembly, and
wherein upon the latch engaging with a reduced section of the male terminal, the latch is automatically returned to the first position by expansion of the compression spring;
pressing on the lock housing to displace the lock housing linearly and compress the compression spring, thereby causing the latch to move the second position; and
moving the plug assembly and header assembly relative to each other until the male terminal is removed from the pocket.
